(19) United States
(12) Patent Application Publication
(10) Pub. No.: US 2010/0178219 A1
(43) Pub. Date: Jul. 15, 2010

(54) HIGHLY HEAT INTEGRATED REFORMER FOR HYDROGEN PRODUCTION

(76) Inventors: Xenophon Verykios, Ag. Vassilios Ahaias (GR); Dimitrios K. Lygouras, Platani Ahaias (GR)

Correspondence Address: HOFFMANN & BARON, LLP, 6900 JERICHO TURNPIKE, SYOSSET, NY, 11791, US

(21) Appl. No.: 12/666,039

(22) PCT Filed: Apr. 22, 2008
(86) PCT No.: PCT/GR2008/000029

§ 371 Date: Mar. 24, 2010

(30) Foreign Application Priority Data
May 25, 2007 (GR) 20070100314

(51) Int. Cl. B01J 8/02

(52) U.S. Cl. 422/197; 422/188

(57) ABSTRACT

Described herein is a highly heat integrated steam reformer/combustor assembly that can be used in a fuel processor for hydrogen production from a fuel source. The assembly comprises a reforming section and a combustion section separated by a wall. Catalyst able to induce the reforming reactions is coated on the wall facing the reforming section. Catalyst able to induce the combustion reactions is coated on the wall facing the combustion section. A steam and fuel mixture is supplied to the reforming section where it is reformed to product hydrogen. A fuel and air mixture is supplied to the combustion section where it is combusted to supply the heat for the reformer. Catalytic combustion takes place on the combustion catalyst coated on one side of the wall while catalytic reforming takes place on the reforming catalyst coated on the other side of the wall. Heat transfer is very facile and efficient across the wall. Multiple such assemblies can be bundled to form reactors of any size.

### FIELD OF THE INVENTION

This invention relates to reactors for hydrogen production and more particular to reactors where hydrocarbons are reformed to produce a hydrogen rich stream.

### BACKGROUND OF THE INVENTION

The use of hydrogen as the new energy vector has gained wide acceptance and is progressing along the road to implementation. Hydrogen can be used in both internal combustion engines and fuel cells. Particularly, its usage in fuel cells to produce electricity or to co-generate heat and electricity represents the most environment friendly energy production process due to the absence of any pollutant emissions and is driven by the growing concerns over greenhouse gas emissions and air pollution. Most importantly, hydrogen can be produced from renewable energy sources such as biofuels, alleviating concerns over the long-term availability of fossil fuels and energy supply security. Applications of such systems include both mobile systems such as vehicle propulsion or auxiliary systems and stationary combined heat and power (CHP) systems for domestic or commercial use.

While the advantages of hydrogen as an energy vector are well accepted, its sourcing and distribution are critical for a successful implementation. Large scale production of hydrogen is well understood and widely practiced in refineries and chemical plants-particularly in the ammonia production industry. For hydrogen to be successfully introduced into the transportation and distributed energy production sectors, refueling and distribution networks must be established. The problem lies in the low energy density of hydrogen which makes its transportation very inefficient and expensive. Transporting hydrogen in compressed or liquid form requires specialized and bulky equipment that minimizes the amount than can be safely carried, increasing resource consumption and cost. This becomes an even bigger issue in the first stages of the implementation when the low demand will not be able to justify costly infrastructure options such as pipeline networks. It is, then, apparent that the hydrogen infrastructure required will be based on distributed production facilities.

Distributed hydrogen production facilities are the focus of numerous research and development activities. While the scale of such facilities is much smaller than the ones employed in the refineries and the chemical plants, the basic steps remain the same. The most commonly employed method involves hydrogen production by the reformation of hydrocarbon fuels. These fuels must already have an established distribution network as to address the raw material availability concerns. They include natural gas, propane, butane (LPG) and ethanol as the representative of the biofuels. Natural gas is mostly methane and can be reformed according to the reaction:

CH₄+H₂O→CO+3H₂ ΔH=49.3 kcal/mol

Propane, butane and ethanol can be reformed according to the reactions:

C₃H₈+3H₂O→3CO+7H₂ ΔH=119.0 kcal/mol

C₄H₁₀+4H₂O→4CO+9H₂ ΔH=155.3 kcal/mol

C₂H₅OH+H₂O→2CO+4H₂ ΔH=57.2 kcal/mol

As can be seen from the heats of reaction (ΔH), all of the reforming reactions are highly endothermic, requiring substantial amounts of heat input. A small fraction of that heat is supplied by the water-gas-shift reaction:

CO+H₂O→CO₂+H₂ ΔH=−9.8 kcal/mol

which occurs in the reforming reactor driving the concentrations of CO and CO₂ to thermodynamic equilibrium. Even so, there is a large deficit that must be covered by an external heat supply. This deficit becomes even larger since the reactions take place at temperatures in the range of 700-900° C. which means that the reactants must be heated-up to such temperatures. The required heat is typically supplied by placing the catalyst containing tubes of the reactor inside a fired furnace. This is a rather inefficient arrangement since there exist severe heat transfer limitations from the heat source to the reactor tubes and then to the catalyst particles where it is actually needed. The difficulty is magnified as the size of the unit becomes smaller where heat losses increase and safety issues dictate a large reactor size. Materials limitations also dictate the avoidance of extremely high temperatures (>1000° C.), further limiting the ability to transfer the required heat and increasing heat losses. All these mean that traditional reactor configurations are very inefficient for distributed hydrogen generation and new configurations must be developed to increase the efficiency and decrease the cost of such systems.

Various configurations have been developed in the past. U.S. Pat. No. 6,387,554 discloses a reactor comprising a bundle of ceramic or metal tubes of small diameter included in a thermically isolated housing. The catalysts are coated on the internal and external surfaces of the tubes and the heat is transferred through the tube walls. A part of the tubes may not be coated with catalyst and may function as a heat exchange zone.

The reactor described in EP Patent No. 0124226 comprises a double-tube reactor that has a steam-reforming catalyst coated on the outside of the internal tube. Alternatively, a group of internal tubes may be installed on a first tubular plate and a group of external tubes on a second tubular plate, the tubular plates being installed around a cylindrical cell in order to define a heat exchange zone. The heat source is a combustor.

A reactor described in EP Patent No. 1361919 comprises a tubular plate bearing a number of extendable pockets that extend vertically into the cell. A second tubular plate extends diagonally along the cell and supports a number of grooved tubular extending channels that correspond to a number of pockets. The channels are open at their ends and extend inward and almost to the edges of the pockets. The catalyst may be coated on the surfaces of the pockets and/or the channels.

### BRIEF DESCRIPTION OF THE INVENTION

The present invention relates to a reformer that produces a hydrogen rich stream by the process known as steam reforming of hydrogen containing compounds. The reformer is comprised of two sections: one where the steam reforming reactions take place and one where combustion of a fuel provides the heat necessary to carry out the reforming reactions. The two sections are separated by a thin metal partition and are in thermal contact as to facilitate the efficient transfer of heat from the combustion to the reforming section. Combustion is mostly catalytic and takes place over a suitable catalyst. Steam reforming is a catalytic reaction and takes place over another suitable catalyst.

In one aspect of the invention, a heat integrated combustor/steam reformer assembly is provided for use in a fuel processor. A fuel and steam mixture is supplied to the reformer to be reformed and a fuel and air mixture is supplied to the combustor to be combusted.

As a feature, the integrated combustor/steam reformer assembly includes a tubular section defined by a cylindrical wall and a housing defining an axially extending concentric annular passage in heat transfer relation to each other. A fuel and air mixture is supplied to the tubular section. The inside wall of the tubular section is coated with a catalyst that includes the desired reaction in the combustor feed. A fuel and steam mixture is supplied to the annular passage. The outside wall of the tubular section is coated with a catalyst that induces the desired reaction in the reformer feed.

As another feature, the integrated combustor/steam reformer assembly includes a tubular section defined by a cylindrical wall and a housing defining an axially extending concentric annular passage in heat transfer relation to each other. A fuel and steam mixture is supplied to the tubular section. The inside wall of the tubular section is coated with a catalyst that induces the desired reaction in the reformer feed. A fuel and air mixture is supplied to the annular passage. The outside wall of the tubular section is coated with a catalyst that induces the desired reaction in the combustor feed.

According to another feature of the invention, the integrated combustor/steam reformer assembly includes a tubular section defined by a cylindrical wall and a housing defining an axially extending concentric annular passage in heat transfer relation to each other. A fuel and air mixture is supplied to the tubular section. The middle part of the inside wall of the tubular section is coated with a catalyst that induces the desired reaction in the combustor feed. A fuel and steam mixture is supplied to the annular passage. The middle part of the outside wall of the tubular section is coated with a catalyst that induces the desired reaction in the reformer feed. The first part of the tubular section not coated with catalyst acts as a heat transfer device allowing heat to be transferred from the hot products of the reforming reaction to the fuel and air mixture entering the combustor so preheating the feed to the combustor while cooling the reforming products. The final part of the tubular section not coated with catalyst acts as a heat transfer device allowing heat to be transferred from the hot products of the combustion reaction to the fuel and steam mixture entering the reformer so preheating the feed to the reformer while cooling the combustion products.

In another aspect of the invention the integrated combustor/steam reformer assembly includes a multitude of tubular sections defined by cylindrical walls separated from each other and supported on each end on plates machined as to allow the cylindrical walls to pass through them and to be in fluid connection with only one side of the plate. The sub-assembly of the tubular sections and the plates is enclosed with a cylindrical housing which isolates the space defined by the inner part of the housing and the plates from being in fluid connection with the surroundings. The inside wall of the tubular sections is coated with a catalyst that induces the desired reaction in the combustor feed. The outside wall of the tubular sections is coated with a catalyst that induces the desired reaction in the reformer feed. The assembly also includes an appropriately shaped reactor head that facilitates the introduction and distribution of the fuel and air mixture inside the tubular sections and an appropriately shaped reactor head that facilitates the collection and exit of the combustion products. A flow passage on one side of the cylindrical housing introduces the fuel and steam mixture in the enclosed reforming section. A second flow passage on the opposite side of the cylindrical housing facilitates the withdrawal of the reforming products.

According to another feature of the invention, metal plates are included inside the cylindrical housing and perpendicular to the tubular sections to guide the flow of the reforming feed, intermediates and products to flow perpendicular to the tubular sections and over several passages.

According to yet another feature of the invention, a metal plate with appropriately shaped openings is placed after the first flow passage on the inside of the cylindrical housing to direct the flow of the reforming feed along the whole length of the tubular sections and perpendicular to them. A second metal plate with appropriately shaped openings is placed before the second flow passage on the inside of the cylindrical housing to direct the flow of the reforming products in the space defined between the plate and the housing and to the second flow passage.

These and other features and advantages of the present invention will become apparent from the following description of the invention and the associated drawings.

### BRIEF DESCRIPTION OF THE DRAWINGS

FIG. 1a is a perspective view of one embodiment of the heat integrated reformer of the invention.

FIG. 1b is a perspective view of another embodiment of the heat integrated reformer of the invention.

FIG. 1c is a perspective view of another embodiment of the heat integrated reformer of the invention.

FIG. 2a is a perspective view of one embodiment of the heat integrated reforming reactor of the invention.

FIG. 2b is a perspective view of another embodiment of the heat integrated reforming reactor of the invention.

FIG. 2c is a perspective view of another embodiment of the heat integrated reforming reactor of the invention.

FIG. 2d is a perspective view of another embodiment of the heat integrated reforming reactor of the invention.

### DETAILED DESCRIPTION OF THE PREFERRED EMBODIMENTS

The present invention is described in detail with reference to a few preferred embodiments illustrated in the accompanying drawings. The description presents numerous specific details included to provide a thorough understanding of the present invention. It will be apparent, however, to one skilled in the art that the present invention can be practiced without some or all of these specific details. On the other hand, well known process steps, procedures and structures are not described in detail as to not unnecessarily obscure the present invention.

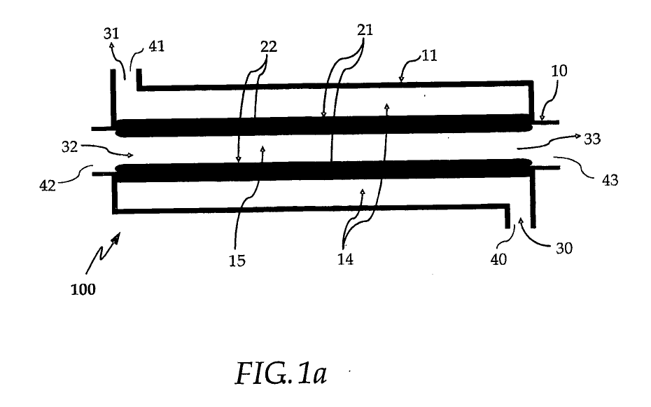

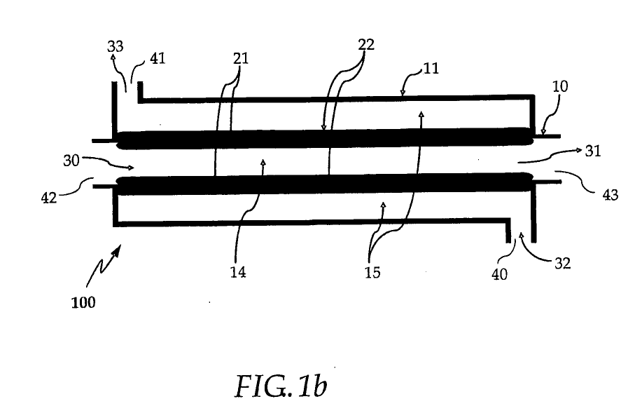

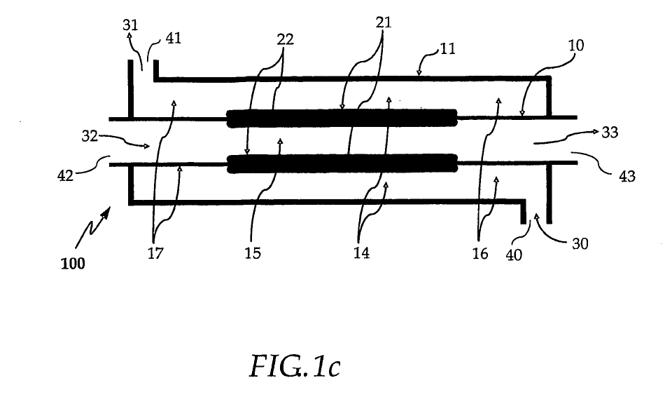

FIG. 1A illustrates the heat integrated reformer according to one embodiment of the present invention. The integrated combustor/steam reformer assembly includes a tubular section defined by a cylindrical wall 10 that separates the combustion zone 15 from the reforming zone 14. The assembly housing 11 acts as the reactor wall and defines an axially extending concentric annular passage in heat transfer relation with the tubular section. A fuel and air mixture 32 is supplied to the tubular section through flow passage 42. The inside wall of the tubular section is coated with a catalyst film 22 that induces the desired reaction in the combustor feed. The products of the combustion reactions 33 exit the tubular section through flow passage 43. A fuel and steam mixture 30 is supplied to the annular passage through flow passage 40. The outside wall of the tubular section is coated with a catalyst film 21 that induces the desired reaction in the reformer feed. The products of the reforming reactions 31 exit the annular passage through flow passage 41. A reformer whose tubular section has a diameter of 25 mm and a length of 800 mm can produce 1 m³/h hydrogen.

The fuel to the combustor can be any available and suitable fuel. Such fuels include methane, natural gas, propane, butane, liquefied petroleum gas, biogas, methanol, ethanol, higher alcohols, ethers, gasoline, diesel etc. For the embodiment illustrated in FIG. 1A, the fuels normally available in liquid form must be vaporized before entering the combustion zone. The same fuels can be fed to the reforming zone to undergo the hydrogen producing reforming reactions. Another potential fuel to the combustor is the hydrogen depleted off-gas from the anode of a fuel cell when the reformer is used as a part of a′ fuel processor producing hydrogen for a fuel cell. Yet another potential fuel to the combustor is the hydrogen depleted off-gas from the pressure swing adsorption (PSA) or any other hydrogen purification device when the reformer is used as a part of a fuel processor producing a hydrogen rich stream that feeds such a device to produce high purity hydrogen.

The temperatures and pressures of the two streams entering the combustor and the reformer respectively need not be the same. Typically, combustion takes place at low or near-atmospheric pressure, although high pressure combustion is widely practiced. Reforming takes place at slightly above atmospheric to moderately high (up to 50 barg) pressures. The cylindrical wall of the tubular section should be of sufficient strength to allow for the pressure differential between the two streams. It is also apparent that different geometries can be used instead of cylindrical shapes should the offer advantages in particular applications. The composition of the mixture entering the combustor should be such as to ensure complete combustion of the fuel. Although a stoichiometric ratio of air to fuel is sufficient, higher ratios can be employed with the present invention. The composition of the mixture entering the reforming section of the assembly is determined by the stoichiometries of the reforming reactions for the given fuel. It is typical practice to provide a higher than stoichiometric steam-to-fuel ratio to minimize possible side reactions that can cause shoot or carbon formation to the detriment of the catalyst and/or the reactor. All suitable steam-to-carbon ratios in the range from 1 to 25 can be employed with the present invention.

The major advantage of the present invention is the heat integration between the combustion 15 and the reforming 14 zones. Combustion takes place on the catalytic film 22 on one side of the wall 10 separating the two zones. Reforming takes place on the catalytic film 21 on the other side of the wall 10 separating the two zones. The wall 10 can be constructed from any material, but materials that offer low resistance to heat transfer such as metals and metallic alloys are preferred. In this configuration, heat is generated by combustion in the catalytic film 22 and is transported very easily and efficiently through the wall 10 to the catalytic film 21 where the heat demanding reforming reactions take place. Heat is generated where it is needed and does not have to overcome significant heat transfer resistances to reach the demand location resulting in high efficiencies.

To accomplish this, the suitable combustion and reforming catalysts must be coated as relatively thin (5-1000 μm thick) films on the opposite sides of the separating wall. Suitable catalysts typically consist of a support and one or multiple metal phases dispersed on the support. The support is typically a ceramic that may contain oxides of one or multiple elements from the IA, IIA, IIIA, IIIB and IVB groups of the periodic table of elements. The metal phase may contain one or multiple elements from the IB, IIB, VIIB, VIIB and VIII groups of the periodic table of elements. The most typical combustion catalysts consist of an aluminum oxide support and a precious or semiprecious metal phase. Typical supports for reforming catalysts consist of oxides of aluminum, silicon, lanthanum, cerium, zirconium, calcium, potassium and sodium. The metal phase of reforming catalysts may contain nickel, cobalt, copper, platinum, rhodium and ruthenium.

Coating of the catalysts on the separating wall can be accomplished by many techniques that depend on the nature of the wall. For ceramic walls, the catalysts are wash-coated by techniques widely known to those skilled in the art. Metal walls pose a bigger problem since the expansion coefficients of the materials are very different and this can lead to catastrophic loss of cohesion during a thermal cycle. In the preferred embodiment, a first base coat is applied by wash-coating, dip-coating, cold spraying or plasma spraying. The coat contains a majority of the desired ceramic, e.g. aluminum oxide or an aluminosilicate, modified with the appropriate compounds, e.g. lanthanum and/or calcium and/or potassium oxides, and a minority of metallic compounds present in the metal alloy of the wall. This can be repeated with coatings containing successively smaller amounts of metallic compounds until the preferred base coat has been laid. The base coat can be further fixed in place by firing at elevated temperatures between 700 and 1200° C. The catalyst can then be wash-coated on the base coat. Alternatively, a second coat of the catalyst support can be wash-coated on the base coat and the metal phase of the catalyst can be impregnated on the catalyst support. In another embodiment, the catalyst support and the metal phase can be prepared as a sol-gel that will coat the base coat and after treatment will fix the catalyst on the base coat. In yet another embodiment, the metal alloy of the separating wall contains elements such as aluminum, yttrium, hafnium etc. that, upon heating the alloy to elevated temperatures between 800 and 1500° C., form complete coats or partial coats of the corresponding oxides on the surface of the wall. The catalyst support can be wash-coated, dip-coated or sprayed on the surface so prepared and the metal phase impregnated on the catalyst support. Alternatively, the catalyst can be directly wash-coated, dip-coated or sprayed on the prepared surface of the wall. In all cases, the catalyst is fixed in place by firing at elevated temperatures between 500 and 1100° C. Before placing the catalyst in service, the metal phase is reduced in hydrogen atmosphere at elevated temperatures between 400 and 900° C.

FIG. 1B illustrates the heat integrated reformer according to another embodiment of the present invention. The integrated combustor/steam reformer assembly includes a tubular section defined by a cylindrical wall 10 that separates the combustion zone 15 from the reforming zone 14. The assembly housing 11 acts as the reactor wall and defines an axially extending concentric annular passage in heat transfer relation with the tubular section. A fuel and air mixture 32 is supplied to the annular passage through flow passage 40. The outside wall of the tubular section is coated with a catalyst film 22 that induces the desired reaction in the combustor feed. The products of the combustion reactions 33 exit the annular passage through flow passage 41. A fuel and steam mixture 30 is supplied to the tubular section through flow passage 42. The inside wall of the tubular section is coated with a catalyst film 21 that induces the desired reaction in the reformer feed. The products of the reforming reactions 31 exit the tubular section through flow passage 43.

FIG. 1C illustrates the heat integrated reformer according to yet another embodiment of the present invention. The integrated combustor/steam reformer assembly includes a tubular section defined by a cylindrical wall 10 that separates the combustion zone 15 from the reforming zone 14. The assembly housing 11 acts as the reactor wall and defines an axially extending concentric annular passage in heat transfer relation with the tubular section. A fuel and air mixture 32 is supplied to the tubular section through flow passage 42. In this embodiment, only the middle part of the inside wall of the tubular section is coated with a catalyst film 22 that induces the desired reaction in the combustor feed. Similarly, only the middle part of the outside wall of the tubular section is coated with a catalyst film 21 that induces the desired reaction in the reformer feed. The catalyst coated parts of the wall function as in the previous embodiments. The parts of the wall not coated with catalyst function as heat exchange regions of the reformer. Heat exchange zone 16 transfers heat from the hot combustion products to preheat the reforming section feed. Heat exchange zone 17 transfers heat from the hot reforming products to preheat the combustion section feed. In this manner, greater heat integration and utilization is accomplished inside the reformer. The products of the combustion reactions 33 exit the tubular section through flow passage 43. A fuel and steam mixture 30 is supplied to the annular passage through flow passage 40. The products of the reforming reactions 31 exit the annular passage through flow passage 41.

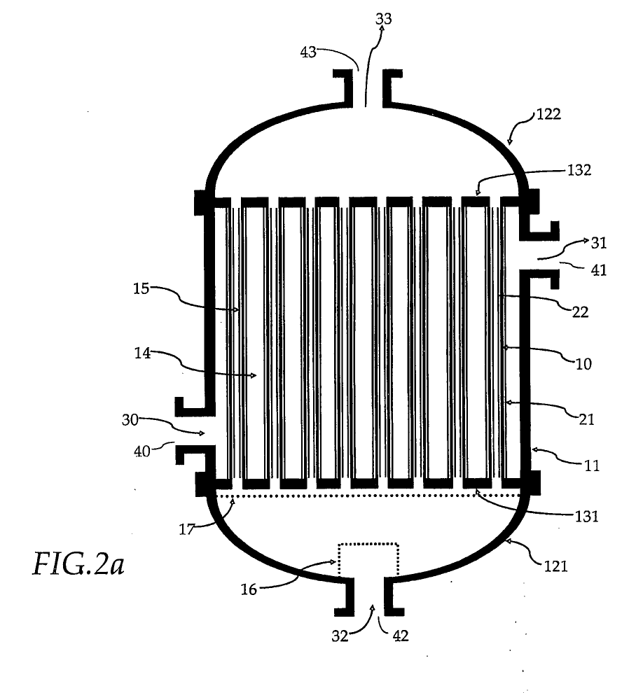

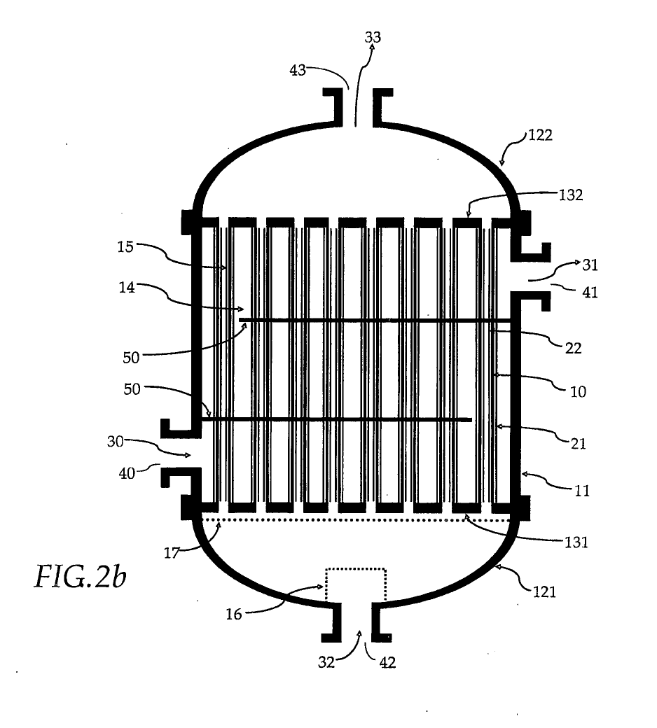

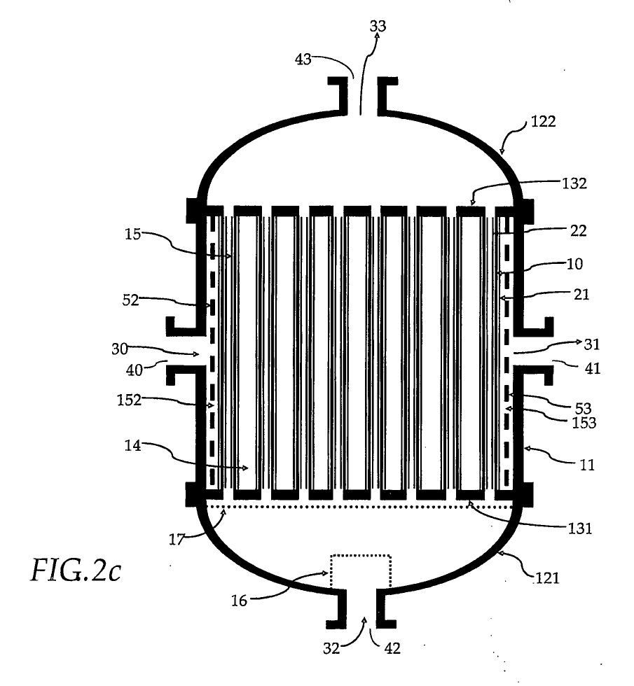

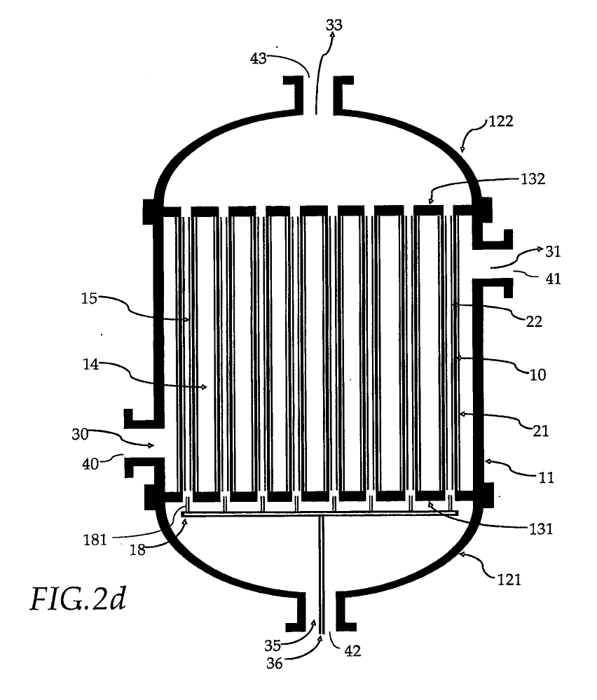

The production capacities of the reformers discussed in the previous examples are limited by their size, i.e. the diameter and length of the sections. Capacities of any size can be achieved by bundling together several such sub-assemblies. FIG. 2A illustrates one embodiment of such a heat integrated reforming reactor. The reactor consists of multiple tubes 10. The inside wall of the tube is coated with a catalyst film 22 that induces the desired combustion reactions. The outside wall of the tube is coated with a catalyst film 21 that induces the desired reforming reactions. The tubes are supported on tube sheets 131 and 132 on each end. The tube sheets are machined as to allow flow contact between the combustor feed, the combustion zone and the combustion product collection spaces. The tubes are welded on the tube sheets as prevent any mixing between the species participating in the reforming reactions and those participating in the combustion reactions. The tube bundles are enclosed by the reactor wall 11 which also attaches to tube sheets 131 and 132 and defines an enclosed space 14 between the tubes 10 and the tube sheets 131 and 132. This space is the reforming zone. The reactor further consists of reactor heads 121 and 122.

The fuel and air feed to the combustor 32 enters the reactor through flow passage 42. The mixture is distributed in the reactor head 121 as to allow for uniform feeding of all tubes 10. Combustion takes place inside the tubes 10 on the catalytic film 22. The combustion products 33 exit at the other end of the tubes supported on tube sheet 132, are collected in the reactor head 122 and leave the reformer through flow passage 43. Since the tubes 10 and tube sheet 131 become very hot during operation, a flame arresting device 17 is placed before tube sheet 131 to prevent back flash and uncontrolled combustion in the reactor head 121. The fuel and steam reforming feed 30 enters the reactor through flow passage 40. The mixture comes in flow contact with the catalyst film 21 that covers the outside wall of the tubes 10. The catalyst induces the reforming reactions and the products 31 exit the reactor through flow passage 41.

FIG. 2B illustrates another embodiment of a heat integrated reforming reactor. The fuel and steam reforming feed 30 again enters the reactor through flow passage 40. One more multiple baffles are placed inside the reactor and perpendicular to the tubes 10 as to force the reacting mixture in a cross-flow multi-passage path through the reactor. This ensures higher fluid velocities, greater turbulence and better contact with the catalyst coated tubes 10. This in turn results in lower mass transfer resistances in the fluid phase and higher reaction efficiencies while increasing the heat transfer rates as well. The products of the reforming reactions 31 again exit the reactor through flow passage 41.

FIG. 2C illustrates yet another embodiment of a heat integrated reforming reactor. The fuel and steam reforming feed 30 again enters the reactor through flow passage 40 which is placed in the middle of the reactor wall 11. A distributor plate 52 is placed inside the reactor and in front of flow passage 40. The distributor place extends from tube sheet 131 to tube sheet 132 and has multiple appropriately shaped openings 152 that allow the passage and uniform distribution of the reactants 30. The reactants flow through the reactor reforming zone 14 perpendicular to the tubes 10 and come in flow contact with the catalyst film 21 that covers the outside wall of the tubes 10 where the reforming reactions take place. A collector plate 53 is placed inside the reactor and on the opposite side of the distributor plate 52. The collector place extends from tube sheet 131 to tube sheet 132 and has multiple appropriately shaped openings 153 that allow the passage and uniform collection of the reforming products 31. The products 31 exit the reactor through flow passage 41. This embodiment offers the same advantages as the embodiment illustrated in FIG. 2B. It allows, however, for lower fluid velocities and for a single passage of the fluid in the reforming zone 14 resulting in lower pressure drop while it may represent a lower cost solution.

FIG. 2D illustrates yet another embodiment of a heat integrated reforming reactor. Since, the tubes 10 and tube sheet 131 become very hot during operation, combustion can be initiated on the front surface of tube sheet 131 and back propagate through reactor head 121 and, possibly, through flow passage 42 if the fuel and air are pre-mixed. To avoid such a potentially very dangerous situation, the air and fuel can be kept separated until they enter the tubes 10 where combustion is desired. Air 35 enters the reactor head 121, gets distributed and uniformly enters the tubes 10 through tube sheet 131. Fuel 36 enters through a manifold 18 and is distributed to each tube through appropriately sized and shaped tips 181. Allowing for a slightly higher pressure for the fuel stream 36 than the air stream 35 also allows for the Venturi effect to develop and prevent any fuel from flowing back. Alternatively, increasing the flow of the air stream 35, pushes the mixture further along the tubes 10 delaying combustion until the mixture is well inside the tubes.

While this invention has been described in terms of several preferred embodiments, there are alterations, permutations and equivalents that fall within the scope of the present invention and have been omitted for brevity. It is therefore intended that the scope of the present invention should be determined with reference to appended claims.

1. A combined and highly thermically integrated steam reformer for the production of hydrogen from a fuel source, comprising:
a) a combustor configured to receive the fuel source and to provide heat to the reformer disposed annularly about the combustor and separated by a wall;
b) the combustor side of the separating wall being coated with a catalyst able to induce the fuel combustion reactions;
c) a reformer configured to receive the fuel source and to output hydrogen;
d) the reformer side of the separating wall being coated with a catalyst able to induce the fuel reforming reactions.

2. A combined and highly thermically integrated steam reformer for the production of hydrogen from a fuel source, the reformer comprising:
a) a reformer configured to receive the fuel source and to output hydrogen and receiving heat from a combustor disposed annularly about the reformer and separated by a wall;
b) a combustor configured to receive the fuel source and to provide heat to the reformer;
c) the combustor side of the separating wall being coated with a catalyst able to induce the fuel combustion reactions;
d) the reformer side of the separating wall being coated with a catalyst able to induce the fuel reforming reactions.

3. A reformer of claim 1 where the separating wall is only partially covered with catalyst on each side so establishing heat exchange zones where heat is transferred between the feed of the combustor and the products of the reformer and between the feed of the reformer and the products of the combustor respectively.

4. A reformer of claim 2 where the separating wall is only partially covered with catalyst on each side so establishing heat exchange zones where heat is transferred between the feed of the combustor and the products of the reformer and between the feed of the reformer and the products of the combustor respectively.

5. An integrated steam reformer/combustor assembly for use in a fuel processing system that supplies a steam and fuel mixture to the reformer to be reformed and produce hydrogen and a fuel and air mixture to the combustor to be combusted and provide the heat to the reformer, the assembly comprising:
a) a multitude of tubular sections where the internal wall of the tube is coated with a catalyst able to induce the combustion reactions and the external wall of the tube is coated with a catalyst able to induce the reforming reactions;
b) tube sheets supporting and spacing the tubular sections;
c) a cylindrical wall enclosing the tubular sections and bonded to the tube sheets and having flow passages for feeding the reforming reactants and removing the reforming products;
d) a first reactor head connected to one tube sheet and having a flow passage for feeding the combustor feed;
e) a second reactor head connected to the other tube sheet and having a flow passage for removing the combustor products.

6. The assembly of claim 5 further comprising a flow distributor inside the first reactor head and connected to its associated flow passage and further a flame arresting device between said flow distributor and tube sheet.

7. The assembly of claim 6 further comprising a set of baffles placed inside the cylindrical wall and perpendicular to the tubular sections to direct the reformer flow across the tubular sections in a recurring manner.

8. The assembly of claim 6 further comprising a distributor plate placed inside the cylindrical wall and between the first flow passage and the tubular sections to direct the reformer feed flow uniformly across the tubes in a cross flow pattern, and further a collector plate placed inside the cylindrical wall and between the second flow passage and the tubular sections to direct the reformer product flow uniformly across the tubes in a cross flow pattern.

9. The assembly of claim 5 further comprising a manifold placed inside the first reactor head with its inlet section passing through the reactor head flow passage and having appropriately shaped tips to feed the fuel directly into the inside of each tubular section.

10. The assembly of claim 9 where only air is fed through the first reactor head flow passage and is mixed with the fuel only inside the tubular sections.
